(19) United States
(12) Patent Application Publication
(10) Pub. No.: US 2024/0234976 A1
(43) Pub. Date: Jul. 11, 2024

(54) ELECTRODE ASSEMBLY FOR A BATTERY HAVING AN ULTRASONIC WELD, METHOD FOR MANUFATURE AND USE OF THE ASSEMBLY

(71) Applicant: LEYDENJAR TECHNOLOGIES B.V., Leiden (NL)

(72) Inventors: Thijs Willem DUBBELINK, Leiden (NL); Arjen Peter DIDDEN, Leiden (NL); Thomas HOMEWOOD, Leiden (NL); Monique LAMHUT, Leiden (NL); Zhaolong LI, Leiden (NL); Dan LUO, Leiden (NL); Yiseop AHN, Leiden (NL)

(73) Assignee: LEYDENJAR TECHNOLOGIES B.V., Leiden (NL)

(21) Appl. No.: 18/559,151

(22) PCT Filed: May 3, 2022
(86) PCT No.: PCT/NL2022/050242

§ 371 Date: Nov. 6, 2023

(30) Foreign Application Priority Data
May 4, 2021 (NL) 2028135

(51) Int. Cl. H01M 50/536; H01M 4/38

(52) U.S. Cl. CPC H01M 50/536; H01M 4/386

(57) ABSTRACT

The present application discloses an electrode assembly, compositions and batteries comprising the electrode assembly, uses of the electrode assembly and a method for producing the electrode assembly comprising the steps of: a. providing at least a first composite electrode material comprising at least one silicon layer on a current collector material; b. providing a welding material in contact with the composite material; and c. providing an electrode tab material in contact with the welding material, to form an aligned electrode assembly stack; and d. optionally, repeating steps a and/or b; and e. applying ultrasonic energy to a portion of the aligned electrode assembly stack to form: i. a weld material ii. a penetration weld through the electrode tab and the welding material and optionally through the composite material; and/or iii. at least an attachment weld between the weld material and the composite material; preferably wherein at least part of the weld material and the tab material form a first weld interface material and at least part of the weld material and the composite material form a second weld interface material, thereby forming the electrode assembly.

### FIELD OF THE INVENTION

The present invention relates to a negative electrode assembly for a battery and its manufacture, in particular to an improved joining between an electrode tab and an electrode comprising a silicon active material and a current collector using ultrasonic welding techniques.

### BACKGROUND OF THE INVENTION

A battery is a device consisting of one or more electrochemical cells with external connections that convert stored chemical energy into electrical energy. A cell has a positive electrode and a negative electrode, also termed respectively a cathode and an anode. When a battery is connected to an external circuit electrons flow from the anode to the cathode through the external circuit thereby delivering electrical energy to the circuit and any devices connected to the circuit.

Primary batteries such as alkaline batteries are one-time-use batteries as the electrode material changes permanently during discharge. Secondary batteries such as lithium-ion batteries can be charged and discharged multiple times as the original composition of the electrode material can be restored by applying a reverse current.

A cell is made up of two half-cells connected in series by a conductive electrolyte material. One of the cells contains the cathode, while the other cell contains the anode with the electrolyte present in both cells. A separator may be present between both cells, which prevents mixing of electrolytes when two different types of electrolytes in each of the cells are used, while still allowing ions to flow between both cells.

An electrode comprises an active material layer, for example consisting mostly of silicon, formed on a current collector, for example a copper sheet, and to which a lead or tab, for example a nickel plate, is connected. The tab is typically connected by welding to an exposed part of the current collector, i.e. upon which no active material is formed or where active material is removed.

However, removing the active material from the current collector or masking the current collector during forming of the active material on the current collector is a difficult and complicated process, which may also put the integrity of the electrode at risk. For example, a high degree of precision is required to produce a suitable exposed area of current collector material during for example slurry coating or vapor deposition methods such as plasma-enhanced chemical vapor deposition (PECVD).

The aforementioned drawback of having to manufacture an electrode with exposed areas of current collector material, can be circumvented by for example indirectly welding the tab to the active material of the electrode. U.S. Pat. No. 9,979,009B2 discloses an energy storage device comprising an electrode tab, a silicon electrode comprising a metal layer that is thinner than the electrode tab and a laser weld coupling the electrode tab to the silicon electrode, wherein a joint of the laser weld comprises a melted material of the electrode tab and in electrical contact with a melted material of the metal layer.

International patent application WO2013080459A1 discloses a tab connected to a negative electrode comprising an active material and a current collector via a melting part that is continuously formed across an end surface of the tab and an end surface of the electrode by arc welding, but not by resistance welding or ultrasonic welding.

A goal of the invention of the present application is to provide an improved method of producing an electrode assembly by welding a tab to an electrode using ultrasonic welding, an electrode assembly comprising an ultrasonic weld attaching a tab to the electrode in an improved fashion, and compositions and batteries comprising assemblies according to the invention. Another goal is to provide electrode assemblies comprising multiple electrodes welded to one tab via one weld and methods for manufacturing the assemblies.

### SUMMARY OF THE INVENTION

In view of the above discussion, the object of the present invention is therefore to provide a method for producing an electrode assembly comprising the steps of:
a. providing at least a first composite electrode material comprising at least one silicon layer on a current collector material;
b. providing a welding material in contact with the composite material; and
c. providing an electrode tab material in contact with the welding material, to form an aligned electrode assembly stack; and
d. optionally, repeating steps a and/or b; and
e. applying ultrasonic energy to a portion of the aligned electrode assembly stack to form:
   i. a weld material;
   ii. a penetration weld through the electrode tab and the welding material and optionally through the composite material; and/or
   iii. at least an attachment weld between the weld material and the composite material;
   thereby forming the electrode assembly;
   preferably wherein at least part of the weld material and the tab material form a first weld interface material and at least part of the weld material and the composite material form a second weld interface material.

It is a further object to provide an electrode assembly obtainable by the method according to the invention.

It is yet a further object to provide a method for connecting two or more electrode assemblies according to the invention, comprising the steps of:
a. contacting the silicon of the composite of a first electrode assembly with either:
   i. a welding layer or a current collector of a second electrode assembly; or
   ii. a welding layer contacted with a second electrode assembly;
b. contacting the welding layer or the current collector with an electrode tab;
c. applying ultrasound energy to at least the electrode tab, thereby generating a weld material, wherein at least part of the weld material and the composite material form a weld interface material, and welding the first electrode assembly to the second electrode assembly.

In a further aspect, the subject of the invention is to provide an electrode assembly comprising:
i) an electrode tab comprising a weld material, wherein at least part of the weld material and the tab material form a first weld interface material;
ii) a first electrode composite material comprising the weld material and a silicon active material layer on a current collector layer, preferably wherein at least part of the weld material and the composite material, preferably silicon, form a second weld interface material; and
(ii) the weld material adjoining the electrode tab and the composite such that tab, composite and weld material are joined in electrical communication with each other.

In yet a further aspect, the subject invention provides a composition comprising at least two assemblies according to the invention, comprising a weld adjoining the tab of a first assembly and the tab of a second assembly.

It is a further object of the invention to provide a battery, comprising an electrolyte, a cathode, a separator and the assembly according to the invention or the composition according to the invention.

It is yet a further object of the invention to provide a use of the assembly, the composition or the battery according to the invention as an energy storage and/or release device.

Applicants have found that with the methods, assemblies, compositions and batteries according to the invention the goal has been achieved.

### SHORT DESCRIPTION OF THE FIGURES

FIG. 1A shows a schematic representation of an electrode assembly stack according to the invention in contact with the horn and anvil of an ultrasonic welding apparatus.

FIG. 1B shows a schematic representation of an electrode assembly stack according to the invention in contact with the horn and anvil of an ultrasonic welding apparatus.

FIG. 2 shows a schematic representation of an electrode assembly according to the invention attached to a circuit for four-point contact resistance measurement.

FIG. 3A shows the top view of a welded electrode tab of an electrode assembly according to the invention.

FIG. 3B shows the bottom view of an electrode assembly according to the invention, wherein a layer of welding material was placed on the bottom.

FIG. 3C shows the bottom view of an electrode assembly according to the invention, wherein no layer of welding material was placed on the bottom.

FIG. 3D shows a cross section view of an electrode assembly according to the invention.

FIG. 4 shows a scanning electron microscopic image of a cross sectional view of an electrode assembly according to the invention, wherein the electrode assembly stack prior to ultrasonic welding consisted of a top tab, welding material, one silicon layer on each side of a current collector material and welding material on the bottom.

FIG. 5A shows an enlarged view of part of FIG. 4.

FIG. 5B shows the same view as FIG. 5A, but presented with intensity levels representing the density of copper as measured by energy-dispersive X-ray spectroscopy.

FIG. 5C shows the same view as FIG. 5A, but presented with intensity levels representing the density of silicon as measured by energy-dispersive X-ray spectroscopy.

FIG. 6 shows scanning electron microscopic image of a cross sectional view of an electrode assembly according to the invention at a higher magnification, wherein the electrode assembly stack prior to ultrasonic welding consisted of a top tab, welding material, one silicon layer on each side of a current collector material and welding material on the bottom.

FIG. 7A shows a scanning electron microscopic image of a cross sectional view of an electrode assembly according to the invention with a connection between the tab layer and the welding material layer at the weld point, whereby a weld material was created.

FIG. 7B shows the same view as FIG. 7A, but presented with intensity levels representing the density of silicon as measured by energy-dispersive X-ray spectroscopy.

FIG. 8A shows a scanning electron microscopic image of a bottom view of an electrode assembly according to the invention, wherein the electrode assembly stack prior to ultrasonic welding consisted of a top tab, welding material, one silicon layer on each side of a current collector material and welding material on the bottom.

FIG. 8B shows the same view as FIG. 8A, but presented with intensity levels representing the density of copper as measured by energy-dispersive X-ray spectroscopy.

FIG. 8C shows the same view as FIG. 8A, but presented with intensity levels representing the density of silicon as measured by energy-dispersive X-ray spectroscopy.

FIG. 9 shows the capacity retention over several charge/recharge cycles comparing three three-anode pouch cell batteries, each having different tab connections.

FIG. 10A depicts this particularly preferred embodiment E4 before welding, FIG. 10B depicts this particularly preferred embodiment E4 after welding, depicting in cartoon form the penetration weld (116).

FIG. 11A depicts this particularly preferred embodiment E5. FIG. 11B depicts this particularly preferred embodiment E5 after welding, depicting in cartoon form the penetration weld (116).

FIGS. 12A and 12B depict a state of the art weld of a composite electrode comprising at least one silicon layer with a thickness of from 0.1 to 500 μm on a current collector material foil with at thickness of from 1 to 100 μm. It depicts significant ablation of parts of the silicon layer from the current collector material, delamination of parts of the silicon layer from the current collector material and cracking of the current collector material.

### DETAILED DESCRIPTION OF THE INVENTION

The inventors have surprisingly found that an electrode tab can be welded to either the silicon active material or the current collector material of a composite electrode by providing a welding material in between the electrode tab and the silicon active material via ultrasonic welding.

Accordingly, the present invention is directed to a method for producing an electrode assembly comprising the steps of:
a. providing at least a first composite electrode material comprising at least one silicon layer on a current collector material;
b. providing a welding material in contact with the composite material; and
c. providing an electrode tab material in contact with the welding material, to form an aligned electrode assembly stack; and
d. optionally, repeating steps a and/or b; and
e. applying ultrasonic energy to a portion of the aligned electrode assembly stack to form:
   i. a weld material;
   ii. a penetration weld through the electrode tab and the welding material and optionally through the composite material; and/or
   iii. at least an attachment weld between the weld material and the composite material;
thereby forming the electrode assembly;
preferably wherein at least part of the weld material and the tab material form a first weld interface material and at least part of the weld material and the composite material form a second weld interface material.

The present invention is also directed to an electrode assembly comprising:
i) an electrode tab comprising a weld material, preferably wherein at least part of the weld material and the tab material form a first weld interface material;
ii) a first electrode composite material comprising the weld material and a silicon active material layer on a current collector material layer, preferably wherein at least part of the weld material and the composite material, preferably silicon, form a second weld interface material; and
iii) the weld material adjoining the electrode tab and the composite such that tab, composite and weld material are joined in electrical communication with each other.

Another aspect of the invention is an electrode assembly obtainable by the method according to the invention.

Ultrasonic welding is a welding technique wherein high-frequency ultrasonic acoustic vibrations are locally applied to elements that are held together under pressure in order to create a solid-state weld. When ultrasonic welding is used to join metals the temperature of the metals typically stays below their melting points thereby preventing unwanted properties that can occur due to high temperature exposure, such as damage to the composite electrode material. Moreover, undesirable intermetallic compounds and metallurgical defects such as brittle phases or porosities in the fused zone, that may result from most fusion welding processes, are prevented.

Ultrasonic welding offers advantages over other welding techniques used in the prior art such as laser welding, arc welding or resistance welding. These advantages are reduced energy requirements, increased speed and safety, in addition to the ability to effectively weld thin layers more precisely.

However, an electrode tab cannot be effectively welded directly to a silicon layer of a composite electrode. Silicon layers formed on current collectors as electrodes usually have a rigid proto-crystalline composition and are therefore brittle. It is therefore expected that exposing the silicon layer material to the thermal stress of welding, and in particular to the additional severe mechanical stress of ultrasonic welding, will cause the silicon layer to be damaged or even destroyed before an effective weld can be established. In addition, indirectly welding an electrode tab to a current collector material which has a silicon layer attached to the current collector on the opposite side of the intended tab to current collector attachment is also expected to cause the silicon layer on the opposite side to be damaged or even destroyed before an effective weld can be established. In this situation the established attachment between the current collector material and the silicon active material prior to welding will thus be negatively affected by the stresses of (ultrasonic) welding.

However, applicant has now surprisingly found that when a welding layer is placed between an electrode tab and a composite electrode material comprising a silicon layer on a current collector material, thereby forming an aligned electrode assembly stack, and applying ultrasonic welding to the assembly stack that a penetration weld is formed through the electrode tab and the welding material and optionally the composite material and a stable mechanical and electrically conductive connection is formed between all of the involved components. Preferably, the welding layer is placed between the electrode tab and a silicon surface of the composite electrode, because this would prevent having to manufacture an electrode with exposed areas of current collector material. In addition, at least part of the weld material and the tab material form a first weld interface material and at least part of the weld material and the composite material form a second weld interface material.

A novel industrial method for manufacturing an anode for use in a secondary battery comprises depositing silicon and/or carbon as the active electrode material on a sheet of a current collector material using chemical vapor deposition (CVD). In order to obtain an exposed section of current collector material to which an electrode tab can be connected, the active material is not deposited on certain defined, masked, parts of the current collector. Tabs are later welded onto these exposed parts of the current collector. Alternatively, the active electrode material may be etched off or removed by techniques such as laser ablation or mechanical grinding after deposition in order to expose the current collector material.

According to the invention an electrode tab can now be connected to an electrode without the need to produce an exposed area of current collector material, while the electrode tab can alternatively now also be connected to the current collector material of an electrode wherein the silicon active material has been attached to the current collector directly opposite of where the tab will be attached. The latter situation can occur when composite electrode materials are provided wherein only one side of the current collector (sheet) has a layer of silicon active material attached. Moreover, the aforementioned advantages of ultrasonic welding can now be employed.

One or more additional tabs can be ultrasonically welded to the assembly according to the invention to improve the weld. In this way the assembly consists of at least two tabs on opposite ends comprising weld material, composite material and optionally welding material sandwiched and welded in between the at least two tabs.

According to the method of invention providing an electrode tab material in contact with the welding material may further comprise providing an additional electrode tab material in contact with the welding material or with the current collector material of the composite material, to form an aligned electrode assembly stack.

A second electrode assembly comprising one or more additional electrode tabs may be produced by a method comprising the steps of:
a. providing a first assembly according to the invention;
b. optionally providing a welding material in contact with the first assembly, preferably with a silicon layer of the first assembly, preferably wherein the welding material is not in contact with a silicon layer that adjoins the tab material of the first assembly; and
c. providing a second electrode tab material in contact with the welding material or with the current collector material of the composite material of the first assembly, preferably the welding material, to form an aligned electrode assembly stack;
d. applying ultrasonic energy to a portion of the aligned electrode assembly stack to form:
   i. a weld material;
   ii. a penetration weld through the second electrode tab and the welding material and optionally through the composite material; and/or
   iii. at least an attachment weld between the weld material and the composite material;
thereby forming the second electrode assembly;
preferably wherein at least part of the weld material and the second tab material form a first weld interface material and at least part of the weld material and the composite material form a second weld interface material.

Accordingly, the assembly according to the invention may comprise a second tab comprising a weld material adjoining the second electrode tab and the composite such that tab, composite and weld material are joined in electrical communication with each other, and preferably wherein at least part of the weld material and the tab material form a first weld interface material. Preferably, according to the method of the invention, the method further comprises providing a welding material in contact with the aligned electrode assembly stack and with the anvil of an ultrasonic welding apparatus prior to applying ultrasonic energy. This can result in a further improved weld according to the invention and can also facilitate the incorporation of even more units of composite material layers into the electrode assembly according to the invention.

Preferably, providing a welding material in contact with the composite material according to the invention comprises providing a welding material in contact with the current collector material or with the at least one silicon layer of the composite material, more preferably providing a welding material in contact with the at least one silicon layer of the composite material.

Preferably, the composite material according to the invention comprises at least one layer of silicon on each of two sides of the current collector material.

Advantageously, according to the invention, the materials are essentially flat, sheet-like materials, and the materials are aligned and fixed prior to, and during the welding process. Electrode materials are commonly produced in an industrial process wherein the electrode active material is deposited as a layer on a sheet of current collector foil, for example by physical vapor deposition (PVD), chemical vapor deposition (CVD) or plasma-enhanced chemical vapor deposition (PECVD). Electrode tabs are commonly also attached to the electrodes in the form of essentially flat, sheet-like materials. A stack of materials that are essentially flat and sheet-like in structure enables an easy alignment and fixing prior to and during welding. Herein, the silicon layer according to the invention is an active material layer. Silicon layer and silicon active material layer are used interchangeably.

Preferably, the assembly according to the invention comprises a welding material.

Preferably, the welding material according to the invention comprises aluminium, gold, copper, iron, lithium, manganese, palladium, platinum, thulium, titanium, tungsten, silver, beryllium, magnesium, nickel, silicon or zirconium, more preferably aluminium, gold or copper, even more preferably copper.

Preferably, the welding material or the current collector material according to the invention each have a thickness of from 1 to 100 μm, preferably of from 5 or 10 to 50 μm, more preferably of from 10 to 15 μm or about 10 or 12 μm.

Advantageously, the current collector material according to the invention comprises copper, tin, chromium, nickel, titanium, stainless steel, or silver, or alloys thereof, more preferably copper or nickel, or alloys thereof, most preferably copper.

The current collector material includes sheet-like materials produced by either cold rolling or electroplating, and can also comprise alloys of copper or titanium with elements such as magnesium, zinc, tin, phosphor and/or silver. It can be smooth, rough, or textured, with a tensile strength preferably ranging from 150 to 600 MPa, and might comprise a passivation layer deposited on the copper foil to protect the copper foil from oxidation in air. The sheet-like materials produced by cold rolling or electroplating can have certain defects such as rolling lines, potential strains, impurities, and native oxide, which can impact the quality of the active material layer. Thus, the current collector material may be subjected to surface treatment. For example, the roughness of the foil can be increased to varying degrees by attaching nodules of current collector material or other metals at the surface of the current collector material, by for example electroplating. Other surface treatment techniques known in the art include annealing, knurling, etching, liquefying, physical polishing and electro-polishing, and are used to improve the morphology of the current collector material prior to deposition of active material.

Preferably, the current collector material according to the invention comprises a metal, metal alloy and/or metal salts and/or oxide.

The metal, metal alloy and/or metal salts and/or oxide according to the invention are advantageously selected from aluminium, copper, nickel, tin, tin, indium and zinc, preferably nickel, ZnO or SnO₂, most preferably ZnO; preferably, wherein the current collector comprises a copper or nickel core layer, more preferably a core layer doped with oxides or fluorides of zinc, aluminium, tin or indium. Preferably, the metal, metal alloy and/or metal salts and/or oxide or the core layer are in a layer at a thickness of from 0.1 to 5 nm, more preferably of from 1 to 2 nm. Preferably, a current collector according to the invention comprising copper or nickel comprises nickel, ZnO or SnO₂.

The term “doping” is herein understood to mean introducing a trace of an element into a material to alter the original electrical properties of the material or to improve the crystal structure of the silicon material.

In the pending international patent application WO2021029769 of current applicant, applicant has found that an adhesion layer comprising a metal, metal alloy and/or metal salts and/or oxide attached to the current collector material, increases adhesion of the silicon material to the current collector material of the composite electrode. According to the present invention, the current collector material comprising a metal, metal alloy and/or metal salts and/or oxide adhesion layer preferably comprises an adhesion layer. This adhesion layer increases the adhesion between silicon material and the current collector material as different complexes of silicon are being formed on the interface between the current collector material and the silicon. Such an adhesion layer preferably comprises nickel, zinc or tin, such as ZnO or SnO₂. The adhesion layer can be formed by coating or depositing the metal, metal alloy and/or metal salts and/or oxide on the current collector material. Preferably, the adhesion layer is in a layer at a thickness of from 0.1 to 5 nm, more preferably of from 1 to 2 nm.

Preferably, according to the invention the at least one silicon layer has a thickness of from 0.1 to 500 μm, preferably of from 1 to 100 or 200 μm, more preferably of from 1 to 30 or 50 μm, most preferably of from 3 or 5 to 15 or 20 μm or about 10 μm. Alternatively, according to the invention, the at least one silicon layer preferably has a mass loading of from 0.1 to 4.0 mg/cm², more preferably of from 0.5 or 0.8 to 2.0 to 2.5 mg/cm², or of from 2.5 to 3.5 or 4.0 mg/cm², most preferably of from 1.0 to 2.0 mg/cm². The mass loading pertains to mass loading of one silicon layer that is present on one side of a current collector layer.

Advantageously, the at least one silicon layer according to the invention has a porosity of from 0% to 50%, more preferably 1%, 2%, 5% or 10% to 50%.

Preferably, the average pore size of the silicon layer is in the range of from 0.5 to 40 nm, preferably of from 1 to 20 nm.

Porosity and (average) pore size according to the invention are preferably determined according to the method specified by the ISO (International Organization for Standardization) standard: ISO 15901-2:2006 “Pore size distribution and porosity of solid materials by mercury porosimetry and gas adsorption—Part 2: Analysis of mesopores and macropores by gas adsorption” using nitrogen gas. Briefly, a N₂ adsorption-isotherm is measured at about −196° C. (liquid nitrogen temperature). According to the calculation method of Barrett-Joyner-Halenda (Barrett, E. P.; Joyner, L. G.; Halenda, P. P. (1951), “The Determination of Pore Volume and Area Distributions in Porous Substances. I. Computations from Nitrogen Isotherms”, Journal of the American Chemical Society, 73 (1): 373-380) the pore size and pore volume can be determined. Specific surface area can be determined from the same isotherm according to the calculation method of Brunauer-Emmett-Teller (Brunauer, S.; Emmett, P. H.; Teller, E. (1938), “Adsorption of Gases in Multimolecular Layers”, Journal of the American Chemical Society, 60 (2): 309-319). Both calculation methods are well-known in the art. A brief experimental test method to determine the isotherm can be described as follows: a test sample is dried at a high temperature and under an inert atmosphere. The sample is then dried and placed in the measuring apparatus. Next, the sample is brought under vacuum and cooled using liquid nitrogen. The sample is held at liquid nitrogen temperature during recording of the isotherm.

The silicon layer according to the invention is preferably attached to the current collector layer or the adhesion layer as a layer comprising a plurality of adjacent columns and aggregated particles with a diameter of at least 5 nm, up to 50 nm, more preferably in the range of from 10 up to 20 nm, the columns extending in a perpendicular direction from the copper foil surface, wherein the adjacent columns are separated by column boundaries extending in the perpendicular direction.

The silicon layer according to the invention has preferably an amorphous structure in which nano-crystalline regions exist. More preferably, the silicon layer or the columns comprise up to 30% of nano-crystalline silicon. According to an embodiment, the silicon layer advantageously comprises n-type or p-type dopants to obtain a silicon layer of respectively n-type conductivity or p-type conductivity.

Advantageously, the silicon columns further comprise a silicon alloy, wherein the silicon alloy is preferably selected from the group comprising Si—C and/or Si—N. Preferably, the composite material according to the invention comprises carbon or an alloy comprising carbon or silicon. The silicon alloy may be either an addition or an alternative to the amorphous silicon. Thus, according to an aspect of the invention, the material of the columns comprises at least one material selected from amorphous silicon and amorphous silicon alloy.

According to a further aspect, the material of the columns comprises amorphous silicon and nano-crystalline silicon alloy. In some embodiments, the silicon alloy may be present in the electrode layer as a nano-crystalline phase. Also, the anode layer may comprise a mixture of an amorphous material and nano-crystalline phase. For example, a mixture of amorphous silicon and nanocrystalline silicon, or a mixture of amorphous silicon with nano-crystalline silicon alloy, or a mixture of silicon and silicon-based alloy predominantly in an amorphous state comprising a fraction (up to about 30%) of the mixture in a nano-crystalline state. According to the present invention, the amorphous silicon columns are preferably extending in a perpendicular direction from the anode surface, i.e. the interface between the anode layer and the electrolyte layer, in which the plurality of silicon columns are arranged adjacent to each other while separated by interfaces extending perpendicularly to the anode surface.

The silicon layer according to the invention may comprise silicon oxide.

The term “amorphous silicon” herein is understood to mean as comprising proto-crystalline silicon, which is a definition for amorphous silicon comprising a fraction of nanocrystalline silicon. This fraction may be up to about 30% of the silicon layer. For ease of reference the term amorphous silicon will be used herein to indicate that the silicon layer comprises amorphous silicon, in which nano-crystalline regions of the silicon layer may be present with a fraction of nanocrystalline silicon up to about 30%.

The silicon layer according to the invention may be on the current collector layer in a variety of configurations. The silicon may be on nanowire templates that are attached to a substrate such as the current collector layer or the adhesion layer. The term “nanowire” herein is understood to mean a branched or non-branched wire-like structure with at least one dimension with a length of up to about 1 μm. The nanowire is an electrically conductive material comprising for example carbon, a metal or a metal silicide such as nickel silicide, copper silicide, silver silicide, chromium silicide, cobalt silicide, aluminium silicide, zinc silicide, titanium silicide or iron silicide, preferably comprising at least one nickel silicide phase comprising Ni₂Si, NiSi or NiSi₂. The nanowire may be the same material as the current collector such as nickel, copper or titanium. Alternatively, the nanowire may be a separate material and layer from the current collector material such as a copper current collector coated with a nickel layer. One or more layers of active material such as silicon may be deposited on nanowires via for example PVD, CVD or PECVD. The silicon layer may comprise carbon, copper, a sulfide, a metal oxide, a fluorine containing compound, a polymer or a lithium phosphorous oxynitride. The silicon layer may be coated with a layer comprising carbon, copper, a sulfide, a metal oxide, a fluorine containing compound, a polymer or a lithium phosphorous oxynitride, preferably a carbon layer with a thickness of from 1 nm to 5 μm, preferably of from 10 nm to 1 μm.

Advantageously, according to the invention, the tab material preferably has a thickness of from 1 μm to 1 mm, more preferably of from 10 to 500 μm, of from 20 to 200 μm, from 50 to 150 μm or about 100 μm.

According to the invention, the tab is preferably a sheet-like material comprising a metal with a thickness of from 1 μm to 1 mm, more preferably of from 10 to 500 μm, of from 20 to 200 μm, from 50 to 150 μm or about 100 μm.

According to the invention the tab material preferably comprises nickel or copper or an alloy comprising nickel, copper, tin, silicon, copper and nickel, copper and tin or copper and silicon. More preferably the tab material comprises nickel.

Preferably, according to the invention if the tab material comprises nickel, the welding material is selected from materials comprising aluminium, gold, copper, iron, lithium, manganese, palladium, platinum, thulium, titanium, tungsten or combinations thereof, more preferably aluminium, gold, copper, lithium or manganese, even more preferably copper; and if the tab material comprises copper but not nickel, the welding material is selected from materials comprising silver, aluminium, gold, beryllium, copper, iron, magnesium, manganese, nickel, palladium, platinum, silicon, thulium, titanium, tungsten, zirconium or combinations thereof, more preferably silver, aluminium, gold, copper or magnesium.

Preferably, the tab material according to the invention has a higher melting temperature point than the melting temperature point of the welding material or the current collector material. More preferably, the tab material according to the invention has a higher melting temperature point than the melting temperature point of the welding material.

Without wishing to be bound to the following theory, it can be speculated that a higher melting temperature of the tab material compared to a lower melting temperature of the welding material enables a penetration weld to be formed in the tab material, wherein the welding material penetrates into the tab material, thereby forming a weld material with a first weld interface. Thus, any welding material having a lower melting temperature point than the melting temperature point of the tab material could be most suitable according to the invention. In addition, the porous structure of the silicon material may facilitate the potential formation of a penetration weld in the composite electrode material. Alternatively, an attachment weld comprising tab material, welding material and/or composite material may be formed having a small or even a minimal penetration into the composite material, which is sufficient for a secure weld and effective electrical communication between the composite material and the tab. Thus, both the penetration weld and the attachment weld can form a weld material with a second weld interface. Penetration of the weld material in the composite material may enable the welding and electrical communication of a plurality of independent layers of composite material to each other and thereby also to the tab material. In this situation, the weld material may comprise or consist of silicon material, welding material and/or current collector material. Preferably, the weld material comprises silicon. Alternatively, an attachment weld having a small or even a minimal penetration into the composite material, the weld comprising tab material, welding material and/or composite material, preferably welding material, current collector material and/or silicon material, may be formed between the independent layers of composite material, which is sufficient for a secure weld and effective electrical communication between the independent layers. Insertion of additional welding material layers in between one or more of the independent layers of composite material could facilitate the subsequent welding of the one or more of the independent layers, but is not necessary. Thus, a plurality of layers of composite material can be welded and in electrical communication with the tab material. Different configurations prior to welding can be foreseen such as for example a stack consisting of subsequently a tab material, one layer of welding material, four layers of composite material, two layers of welding material, two layers of composite material, one layer of welding material, five layers of composite material and one layer of welding material, wherein the welding material is in contact with the at least one silicon layer of the composite material. A welding layer, which is not in contact with the tab material may also be in contact with the current collector material of the composite material. Therefore, according to the method of the invention, step d. preferably comprises repeating step a. and/or b., preferably step a. and b., at least once, for example 2 to 100 times, 3 to 50 times, 4 to 30 times, 10 to 20 times or 4 to 9 times. For example, a composition according to the invention to be used in a large pouch cell has step a. and/or b. repeated about 50 times.

Without wishing to be bound to the following theory it can be speculated that the welding material according to the invention enables a dissipation of energy (e.g. thermal and/or vibration) generated by the ultrasonic welding apparatus during ultrasonic welding. This dissipation of energy prevents damage to or destruction of the more rigid silicon active material of the composite electrode material by the ultrasonic welding and thus enables the manufacture of an electrode assembly according to the invention, optionally having multiple units of composite electrode material incorporated therein.

According to the method of the invention, the method preferably comprises a step of, before the step of applying ultrasonic energy, holding in place the assembly stack in a layered manner by applying pressure, preferably with a pressure of from 50 kPa or 200 kPa to 700 kPa or 1500 kPa, more preferably of from 250 kPa to 550 kPa, or of from 300 kPa to 500 kPa, or about 415 kPa.

According to the method of the invention, applying the energy preferably comprises applying the energy via ultrasonic acoustic vibrations. The term “ultrasound” herein is understood to mean sound waves with a frequency of from 10 KHz and higher.

According to the method of the invention, applying the energy preferably comprises applying the energy at a frequency of from 10 to 200 kHz, more preferably of from 20 to 100 kHz, of from 20 or 40 to 80 kHz, most preferably of from 20 to 60 kHz, of from 30 to 50 kHz, of from 20 to 40 kHz, of from 40 to 60 kHz, of from 35 to 45 kHz, or about 40 KHz.

According to the method of the invention, applying the energy preferably comprises applying the energy with a duration of from 0.01 to 100 s, more preferably of from 0.01 to 50 s, of from 1 to 30 s, of from 2 to 20 s, of from 3 to 10 s or of from 4 to 8 s. Preferably, according to the method of the invention, applying the energy comprises applying the energy with a duration of from 0.01 to 100 s for each separate composite electrode material, more preferably of from 0.01 to 50 s, of from 1 to 30 s, of from 2 to 20 s, of from 3 to 10 s, of from 4 to 8 s, even more preferably of from 0.05 to 5 s, of from 0.1 to 3 s, of from 0.5 to 2 s, of from 0.8 s to 1.6 s. For example, when 10 composite electrode material layers are contacted with each other prior to welding, the duration of applying the energy has a total duration of from 10×0.01 to 100 s, which is equal to from 0.1 to 1000 s.

According to the method of the invention, applying the energy preferably comprises applying the energy with a power of from 200 W to 10 KW, more preferably of from 500 W to 5 or 6 KW, from 800 W to 3 or 4 KW or from 1 KW to 2 KW. The energy can be applied to a surface area of for example about 9 mm². A such, according to the method of the invention, applying the energy preferably comprises applying the energy with a power of from 22 W/mm² to 1100 W/mm², more preferably of from 55 W/mm² to 555 W/mm² or 666 W/mm², from 90 W/mm² to 333 W/mm² or 444 W/mm² or from 111 W/mm² to 222 W/mm².

According to the method of the invention applying the energy preferably comprises applying the energy via oscillating a sonotrode, preferably with an amplitude of from 1 to 130 μm, more preferably of from 5 to 50 μm or from 10 to 30 μm.

The person skilled in the art understands that by adjusting the vibration frequency, the vibration amplitude and the power of the ultrasonic welding device, adjusting the duration and adjusting the holding in place the assembly stack in a layered manner by applying pressure, a multitude of different combinations of parameters is possible that could, according to the method of the invention, enable a portion of the aligned electrode assembly stack to form a weld material; a penetration weld through the electrode tab, welding material and optionally the composite material; and/or at least an attachment weld between the weld material and the composite material, wherein preferably at least part of the weld material and the tab material form a first weld interface material and at least part of the weld material and the composite material form a second weld interface material, thereby forming the electrode assembly. For example, a higher frequency with a lower duration may produce the same results as a lower frequency with a longer duration. However, a successful weld according to the invention depends not only on the combination of welding parameters, but also on the (combination of the) materials to be welded.

The first weld interface material according to the invention preferably comprises the tab material and the welding material or an alloy thereof, or the tab material and the welding material and the composite material, preferably silicon, or an alloy thereof.

The second weld interface material according to the invention preferably comprises the welding material and the composite material, preferably silicon, or an alloy thereof, or the tab material and the welding material and the composite material, preferably silicon, or an alloy thereof.

The term “weld interface” herein is understood to mean a new hybrid area that is formed in a first material after ultrasonic welding of the first material and at least one second material, the hybrid area comprising at least the first material and the at least one second material in a mixed configuration. When additional materials are subjected to the ultrasonic welding the weld interface may comprise one or more of these additional materials. The mixed configuration may be an ordered or disordered alloy, an intermetallic alloy or a homogeneous mixture, wherein the composition and properties are uniform throughout the mixture, and/or a heterogeneous mixture, wherein the composition and properties are not uniform throughout the mixture, or combinations thereof. Preferably, the first weld interface material is an alloy. Preferably, the second weld interface material is a heterogeneous mixture.

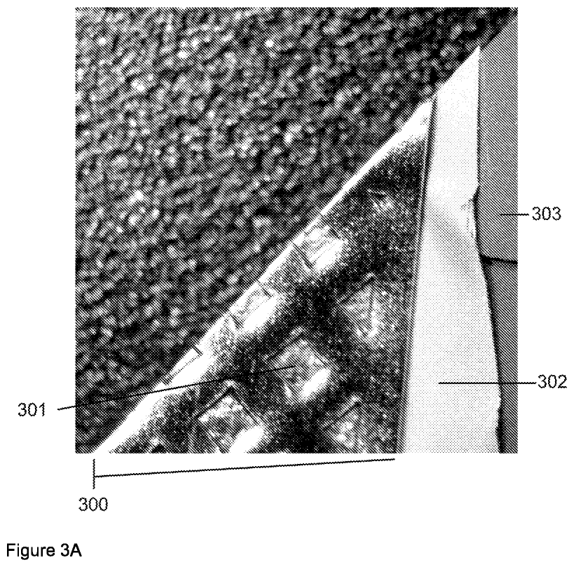

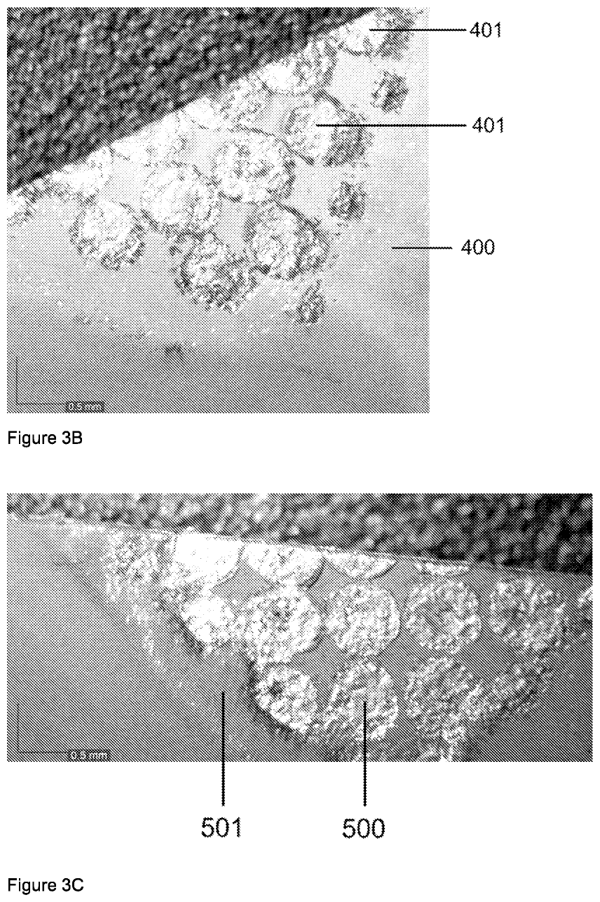

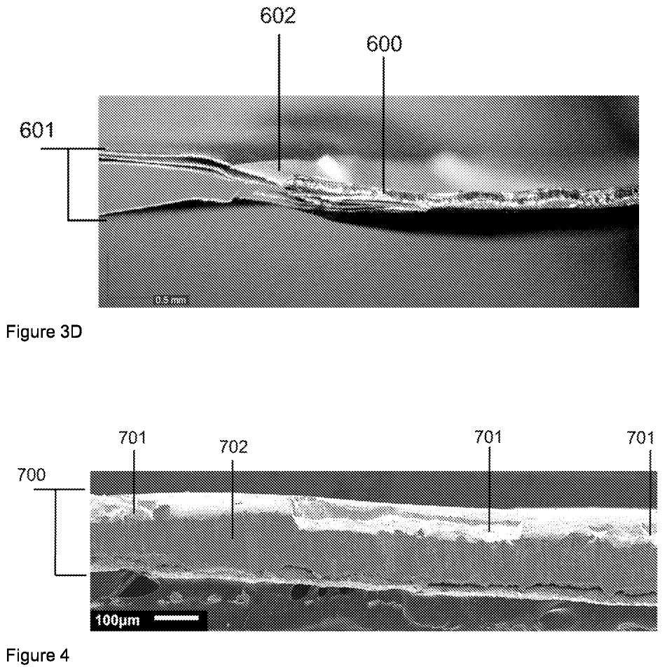

Exemplary weld interfaces are shown in FIGS. 3 to 8.

Preferably, according to the invention the weld material comprises silicon and extends into, is extended into or penetrates the current collector material, the welding material and/or the tab material.

Preferably, according to the invention the weld material comprises the welding material and extends into, is extended into or penetrates the composite material, the current collector material, the silicon layer and/or the tab material. More preferably, the weld material comprises the welding material and extends into, is extended into or penetrates the tab material. Preferably, the weld material comprises the welding material and forms an attachment with the composite material, preferably the current collector material or the silicon, more preferably the silicon or the silicon layer.

Preferably, according to the invention the weld material comprises the tab material and extends into, is extended into or penetrates the composite material, the current collector material, the welding material and/or the silicon layer. Preferably, the weld material comprises the tab material and extends into, is extended into or penetrates the welding material.

Preferably, according to the invention the weld material comprises the current collector material and extends into, is extended into or penetrates the silicon layer, the welding material and/or the tab material. More preferably, the weld material comprises the current collector material and extends into, is extended into or penetrates the tab material.

According to the invention, the weld material preferably extends into, is extended into or penetrates the composite material throughout at least 0.01 to 0.1% or at least 0.1 to 1% of a dimension of the composite material, at least 10 to 20% of a dimension of the composite material, throughout at least 20 to 50% of a dimension of the composite material, throughout at least 50 to 90% of a dimension of the composite material, or throughout at least 0.01%, 0.1%, 1%, 5%, 10%, 20%, 50%, 90%, 95%, 99% or 100% of a dimension of the composite material.

According to the invention, the weld material preferably extends into, is extended into or penetrates the tab material throughout at least 5 or 10 to 20% of a dimension of the tab material, more preferably throughout at least 20 to 50% of a dimension of the tab material, even more preferably throughout at least 50 to 90% of a dimension of the tab material, or throughout at least 5%, 10%, 20%, 50%, 90%, 95%, 99% or 100% of a dimension of the tab material.

During welding, the weld material is formed in a direction mostly determined by the direction of the ultrasonic acoustic vibrations that originate from the sonotrode, which are typically mostly directed in an axial direction towards the anvil. During welding, the weld material thus extends into or penetrates the tab material and optionally the composite material preferably along a dimensional direction mostly determined by the direction of the ultrasonic acoustic vibrations.

Advantageously, according to the invention the weld material preferably comprises silicon and extends into, is extended into or penetrates the current collector material or the welding material.

The structure and composition of exemplary weld material is shown in FIGS. 3 to 8.

Preferably, the assembly according to the invention comprises one or more, preferably 4 to 9, additional composites in electrical communication with each other and with the first composite. Without being bound by the following theory, it is speculated that the weld material may extend into or penetrate into a subsequent connecting composite material whereby prior to welding no welding material was in contact with the subsequent composite material. The above effect may therefore help to enable multiple composite materials to be connected to each other and the tab material via one weld generated by one welding action.

According to the invention, the weld material, the welding material or the weld interface material preferably comprises aluminium, gold, copper, iron, lithium, manganese, palladium, platinum, thulium, titanium, tungsten, silver, beryllium, magnesium, nickel, silicon or zirconium. Preferably, the weld material or the welding material comprises copper and nickel.

The assembly according to the invention preferably has a resistance of equal to or less than 20 mΩ, preferably less than 10 mΩ, between the distal end of the tab and the proximal end of composite, wherein the weld material adjoins the electrode tab and the composite with a surface area of about 9 mm², as determined by a volt-ohm-milliammeter using a four-point measurement structure.

The tab material and the silicon of the composite of the assembly according to the invention preferably have a connection with an adhesive strength of at least 0.5 or 1 N/mm, preferably of at least 5 or 8 N/mm, more preferably of at least 10, 11, 12, 13 or 14 N/mm.

The tab material and the silicon of the composite of the assembly according to the invention preferably have a connection with an adhesive strength of from 0.5 or 1 to 100 N/mm, preferably of from 5 or 8 to 100 N/mm, more preferably of from 10 to 12 to 15, 20 or 100 N/mm or about 14 N/mm.

The tab material and the welding material of the assembly according to the invention preferably have a connection with an adhesive strength of at least 0.5 or 1 N/mm, preferably of at least 5 or 8 N/mm, more preferably of at least 10, 11, 12, 13, 14 or 15 N/mm. The tab material and the welding material of the assembly according to the invention preferably have a connection with an adhesive strength of from 0.5 or 1 to 100 N/mm, preferably of from 5 or 8 to 100 N/mm, more preferably of from 10 to 12 to 18, 20 or 100 N/mm or about 15 N/mm.

The weld material according to the invention is preferably an ultrasonic weld material. The term “ultrasonic weld material” herein is understood to mean a weld material formed by ultrasonic welding. An ultrasonic weld or weld material can be identified by a combination of characteristics that are specific to the result of ultrasonic welding. These characteristics can for example be assessed via optical or (scanning) electron microscopy. Examples of these characteristics are indentations of the sonotrode and/or anvil on the surface of the contacted materials, micro-bonds (metallurgical adhesion), interfacial waves (mechanical interlocking), and deformed material overflowing into a space that is not into contact with the sonotrode, as for instance disclosed in “Characterization of Joint Quality in Ultrasonic Welding of Battery Tabs” S. Shawn Lee, Tae Hyung Kim, S. Jack Hu, Wayne W. Cai, Jeffrey A. Abell, Jingjing Li, J. Manuf. Sci. Eng., April 2013, 135(2): 021004 (13 pages).

Another aspect of the invention is a method for producing a composition comprising the steps of:
a. providing a first assembly according to the invention;
b. providing a second assembly according to the invention;
c. contacting an electrode tab of the first assembly with an electrode tab of the second assembly; and
d. welding the tabs, thereby adjoining the tab of the first assembly with the tab of the second assembly such that they are joined in electrical communication with each other.

Another aspect of the invention is a composition comprising at least two assemblies according to the invention, comprising a weld adjoining the tab of a first assembly with the tab of a second assembly.

Another aspect of the invention is a method for producing a composition comprising the steps of:
a. providing a first assembly according to the invention;
b. providing a second assembly according to the invention;
c. providing an electrode tab material;
d. optionally providing a welding material in contact with the first and second assembly;
e. contacting in order to form a composition stack:
   i. at least the current collector material of at least one assembly with the other assembly; or
   ii. the welding material with each assembly;
   iii. the tab material with the current collector material or the welding material;
applying ultrasonic energy to a portion of the composition stack to form a weld material; a penetration weld through the tab material and the welding material or the current collector material, wherein preferably at least part of the weld material and the tab material form a first weld interface material; and/or a penetration or attachment weld through the first and second assembly, wherein preferably at least part of the weld material and the composite material form a second weld interface material, thereby forming the composition.

Another aspect of the invention is a composition comprising at least two assemblies according to the invention, comprising a weld comprising weld material adjoining, preferably penetrating, the composite of a first assembly and the composite of a second assembly, wherein at least part of the weld material and the composite material, preferably silicon, form a second weld interface material.

A further aspect of the invention is a battery, comprising an electrolyte, a cathode, a separator and the assembly or the composition according to the invention.

The battery according to the invention preferably comprises an electrolyte comprising a medium and a lithium salt compound arranged between the cathode and the assembly.

The medium may be liquid or solid. An electrolyte comprising a liquid medium and a lithium salt may for example consist of any of LiPF₆, LiBF₄ or LiClO₄ in an organic solvent such as ethylene carbonate, dimethyl carbonate, propylene carbonate, ethyl methyl carbonate, diethyl carbonate, or mixtures of any combination thereof, or other lithium salts and solvents known in the art such as room-temperature ionic liquids. The electrolyte may be solid such as a ceramic electrolyte. The lithium salt in a solid ceramic electrolyte is usually present as a lithium metal oxide. Examples of solid ceramic electrolytes are lithium super ion conductors and perovskites optionally arranged as an amorphous structure.

The battery according to the invention preferably comprises a single assembly or composition or a multitude of assemblies or compositions. The single assembly or composition or a multitude of assemblies or compositions according to the invention may be folded or rolled to obtain a suitable configuration for use in a battery.

Advantageously, the battery according to the invention preferably has the electrolyte, cathode, separator and assembly or composition in a rolled or folded configuration or contained within a non-metallic pouch.

Examples of such cells are cylindrical, prismatic, pouch and coin cells. Several configurations of cells can also be combined. For example, a coin cell can have an internal cylindrical configuration (as disclosed in international patent application WO2015188959A1) or a pouch cell can have an internal prismatic configuration.

Preferably, the battery according to the invention comprises a single anode electrode tab. Preferably, such a battery comprises a prismatic cell or a cylindrical cell.

An additional aspect of the invention is the use of the assembly, the composition or the battery according to the invention as an energy storage and/or release device.

The term “energy storage and/or release device” herein is understood to mean a secondary battery, including an electrode assembly of a cathode/separator/anode structure mounted in a suitable battery case. Such batteries include lithium ion secondary batteries, which are excelling in providing high energy density, and a high capacity; and their use in secondary battery modules comprising a plurality of secondary batteries, which are typically connected in series with each other to form a battery pack that can be incorporated into a casing to form the module.

In a particularly preferred embodiment E1, the invention relates to a method for producing an electrode assembly comprising the steps of:
a. providing at least a first composite electrode material comprising at least one silicon layer with a thickness of from 0.1 to 500 μm on a current collector material foil with at thickness of from 1 to 100 μm;
b. providing a welding material in contact with the silicon layer, with the welding material possessing a thickness of from 0.1 to 500 μm, of the composite material; and
c. providing an electrode tab material in contact with the welding material, to form an aligned electrode assembly stack; and
e. applying ultrasonic energy to a portion of the aligned electrode assembly stack to form:
i. a penetration weld through the electrode tab, the welding material and through the silicon layer with a thickness of from 0.1 to 500 μm thereby forming the electrode assembly.

This particularly preferred embodiment E1 allows contact tabs to be brought into electrical communication with the current collector material though an electrically conductive weld that penetrates the silicon layer with a thickness of from 0.1 to 500 μm without the silicon layer exhibiting significant:
(i) ablation of parts of the silicon layer from the current collector material;
(ii) delamination of parts of the silicon layer from the current collector material; or
(iii) cracking of the current collector material.

This result is surprising given that thin layers of silicon with a thickness of from 0.1 to 500 μm tend to be frangible, and generally tend to ablate and delaminate from the current collector under thermal or physical stress of traditional welding techniques.

The product directly obtained by the method of this embodiment E1 may be distinguished from those made by known methods in that the weld penetrates the silicon layer with a thickness of from 0.1 to 500 μm and does not exhibit ablation or delamination near the weld site. This may be confirmed by scanning electron microscopy of (i) the surface of the weld and (ii) of a cross section of the weld.

In a particularly preferred embodiment E2, the invention relates to a method for producing an electrode assembly comprising the steps of:
a. providing at least a first composite electrode material comprising two silicon layers, both with a thickness individually selected of from 0.1 to 500 μm on both sides of a current collector material foil with at thickness of from 1 to 100 μm;
b. providing at least one welding material in contact with both silicon layers, with the welding material possessing a thickness of from 0.1 to 500 μm, of the composite material; and
C. providing an electrode tab material in contact with the welding material, to form an aligned electrode assembly stack; and
e. applying ultrasonic energy to a portion of the aligned electrode assembly stack to form:
i. a penetration weld through the electrode tab, the welding material and through both silicon layers with a thickness individually selected of from 0.1 to 500 μm
thereby forming the electrode assembly.

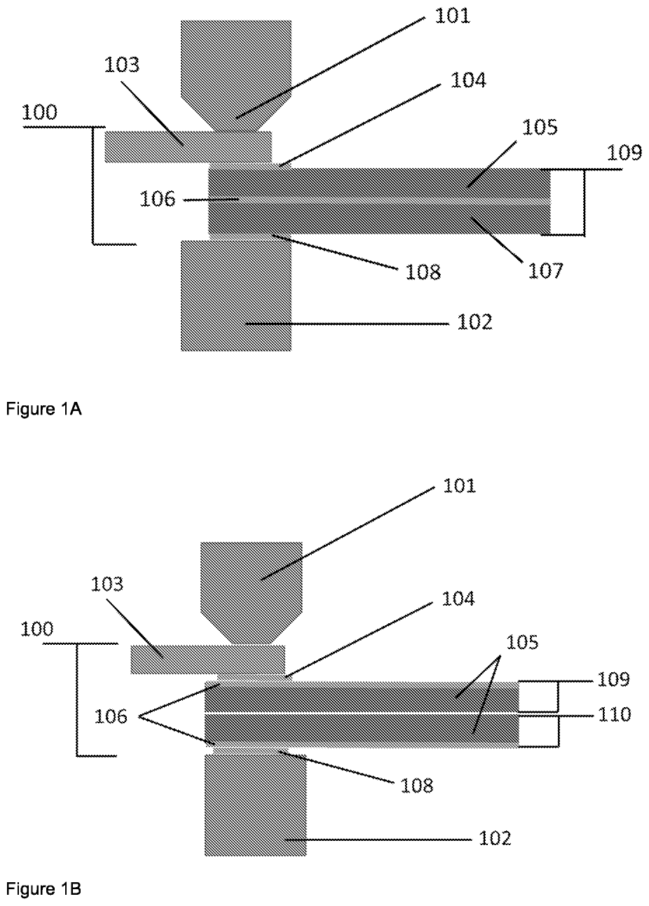

This embodiment E2 is depicted in FIG. 1A.

This result is surprising given that thin layers of silicon with a thickness of from 0.1 to 500 μm tend to be frangible, and generally tend to ablate and delaminate from the current collector under thermal or physical stress of traditional welding techniques.

The product directly obtained by the method of this embodiment E2 may be distinguished from those made by known methods in that the weld penetrates the silicon layer with a thickness of from 0.1 to 500 μm and does not exhibit ablation or delamination proximal to the weld site. This may be confirmed by scanning electron microscopy of (i) the surface of the weld and (ii) of a cross section of the weld.

It is readily apparent that the weld material may be a C-shaped piece of metal that caps an end of the composite electrode material, thus both inner ends of the C-shaped piece of metal may be brought into contact with the silicon layers of the composite electrode material. Alternative shapes and configurations may be readily envisaged.

Alternatively, but equally preferably, step b may read as follows:
b. providing two sets of welding material, with a first set of welding material in contact with a first silicon layer of the composite material, a second set of welding material in contact with a second silicon layer of the composite material, with the sets of welding material possessing a thickness individually selected of from 0.1 to 500 μm; and

The sets of welding material may be a strip of metal foil, such as copper.

This provides the same technical effect and benefits as where a single welding piece is employed.

In a particularly preferred embodiment E3, the invention relates to a method for producing an electrode assembly comprising the steps of:
a. providing a first composite electrode material comprising at least one silicon layer with a thickness of from 0.1 to 500 μm on a current collector material foil with at thickness of from 1 to 100 μm;
b. providing a second composite electrode material comprising at least one silicon layer with a thickness of from 0.1 to 500 μm on a current collector material foil with at thickness of from 1 to 100 μm;
c. bringing the silicon layer with a thickness of from 0.1 to 500 μm of the first composite electrode material and the silicon layer with a thickness of from 0.1 to 500 μm of the second composite electrode material into contact;
d. providing a welding material in contact with the current collector material foil of the first composite electrode material, with the welding material possessing a thickness of from 0.1 to 500 μm;
e. providing a welding material in contact with the current collector material foil of the second composite electrode material, with the welding material possessing a thickness of from 0.1 to 500 μm;
f. providing an electrode tab material in contact with the welding material, to form an aligned electrode assembly stack; and
g. applying ultrasonic energy to a portion of the aligned electrode assembly stack to form:
i. a penetration weld through the electrode tab, the welding material, both current collector material foils and through both silicon layers with a thickness of from 0.1 to 500 μm,
thereby forming the electrode assembly.

This particularly favoured embodiment E3 is depicted in FIG. 1B.

This particularly preferred embodiment E3 allows contact tabs to be brought into electrical communication with the current collector material though an electrically conductive weld that penetrates the silicon layer with a thickness of from 0.1 to 500 μm without the silicon layer exhibiting significant:
(i) ablation of parts of the silicon layer from the current collector material;
(ii) delamination of parts of the silicon layer from the current collector material; or
(iii) cracking of the current collector material.

This result is exceptionally surprising in allowing two silicon layers to be welded together, given that thin layers of silicon with a thickness of from 0.1 to 500 μm tend to be frangible, and generally tend to ablate and delaminate from the current collector under thermal or physical stress of traditional welding techniques.

The product directly obtained by the method of this embodiment E3 may be distinguished from those made by known methods in that the weld penetrates both the silicon layers with a thickness of from 0.1 to 500 μm and does not exhibit ablation or delamination near the weld site. This may be confirmed by scanning electron microscopy of a cross section of the weld.

In the absence of the welding material, poor adhesion between the two silicon layers is observed.

In a particularly preferred embodiment E4, the invention relates to a method for producing an electrode assembly comprising the steps of:
a. providing a first composite electrode material (109) comprising at least one silicon layer (105) with a thickness of from 0.1 to 500 μm on a current collector material foil (106) with at thickness of from 1 to 100 μm;
b providing a second composite electrode material (111) comprising a first and a second silicon layers (105), both with a thickness individually selected of from 0.1 to 500 μm on either side of a current collector material foil (106) with at thickness of from 1 to 100 μm;
c providing a welding material (114) possessing a thickness of from 0.1 to 500 μm between and in contact with: (i) the silicon layer of the first composite electrode material (105); and (ii) the first silicon layer (105) of the second composite electrode material (111);
d. providing a third composite electrode material (112) comprising at least one silicon layer (105) with a thickness of from 0.1 to 500 μm on a current collector material foil (106) with at thickness of from 1 to 100 μm;
e. providing a welding material (115) possessing a thickness of from 0.1 to 500 μm between and in contact with: (i) the silicon layer (105) of the third composite electrode material (112); and (ii) the second the silicon layer (105) of the second composite electrode material (111);
f. providing a welding material (104) in contact with the current collector material foil (106) of the first composite electrode material (109), with the welding material possessing a thickness of from 0.1 to 500 μm;
g. optionally providing a welding material (108) in contact with the current collector material foil of the third composite electrode material, with the welding material possessing a thickness of from 0.1 to 500 μm;
h. providing an electrode tab material (103) in contact with the welding material (104), to form an aligned electrode assembly stack (116); and
i. applying ultrasonic energy to a portion of the aligned electrode assembly stack to form a penetration weld connecting the electrode tab (114), through the welding materials (104, 114, 115), through the silicon layers (105) with a thickness of from 0.1 to 500 μm to the current collector material foils (106), thereby forming the electrode assembly.

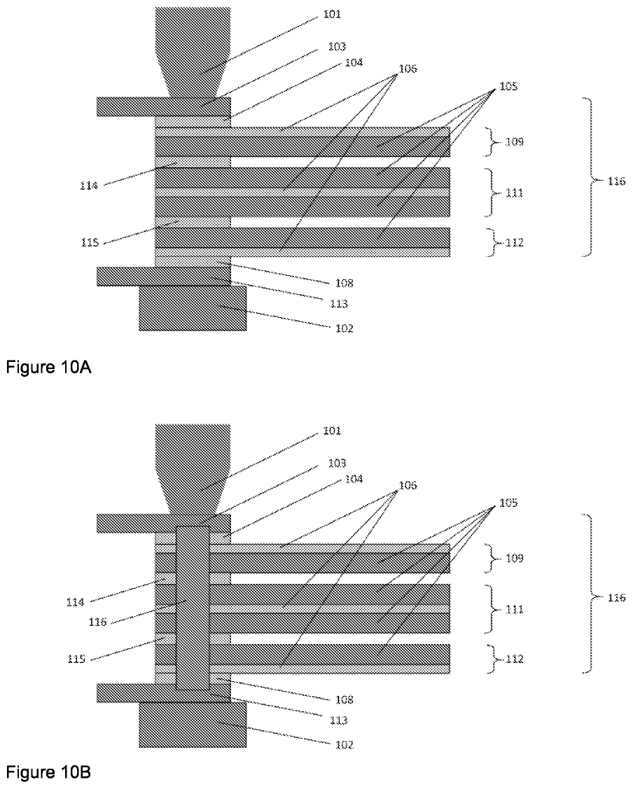

FIG. 10A depicts this particularly preferred embodiment E4 before welding, FIG. 10B depicts this particularly preferred embodiment E4 after welding, depicting in cartoon form the penetration weld (116). The composition of the penetration weld (116) is electrically conducting. The composition of the penetration weld (116) varies from top to bottom, and comprises material originally found in the layers (103, 104, 105, 106).

This particularly preferred embodiment E4 allows the current collector material of multiple anodes to be directly connected to an electrode tab, allowing more condensed anode assemblies. In particular, contact tabs may be brought into electrical communication with the current collector material though an electrically conductive weld that penetrates the silicon layer with a thickness of from 0.1 to 500 μm without the silicon layer exhibiting significant:
(i) ablation of parts of the silicon layer from the current collector material;
(ii) delamination of parts of the silicon layer from the current collector material; or
(iii) cracking of the current collector material.

This result is exceptionally surprising in allowing multiple silicon layers of different electrode assemblies, such as anodes, to be welded together, given that thin layers of silicon with a thickness of from 0.1 to 500 μm tend to be frangible, and generally tend to ablate and delaminate from the current collector under thermal or physical stress of traditional welding techniques.

The product directly obtained by the method of this embodiment E4 may be distinguished from those made by known methods in that the weld penetrates both the silicon layers with a thickness of from 0.1 to 500 μm and does not exhibit ablation or delamination near the weld site. This may be confirmed by scanning electron microscopy of a cross section of the weld.

In the absence of the welding material between the silicon layers of alternating composite electrode material layers, poor adhesion between the two silicon layers is observed.

The method may optionally comprise the additional steps of:
providing a second electrode tab material (113) in contact with the welding material (108).

In a particularly preferred embodiment E5, the invention relates to a method for producing an electrode assembly comprising the steps of:
a. providing a first composite electrode material (109) comprising a first and a second silicon layers (105), both with a thickness individually selected of from 0.1 to 500 μm on either side of a current collector material foil (106) with at thickness of from 1 to 100 μm;
b. providing a second composite electrode material (111) comprising a first and a second silicon layers (105), both with a thickness individually selected of from 0.1 to 500 μm on either side of a current collector material foil (106) with at thickness of from 1 to 100 μm;
c. providing a third composite electrode material (112) comprising a first and a second silicon layers (105), both with a thickness individually selected of from 0.1 to 500 μm on either side of a current collector material foil with (106) at thickness of from 1 to 100 μm;
d. providing a welding material (114) possessing a thickness of from 0.1 to 500 μm between and in contact with: (i) the second silicon layer (105) of the first composite electrode material (109); and (ii) the first silicon layer (105) of the second composite electrode material (111);
e. providing a welding material (115) possessing a thickness of from 0.1 to 500 μm between and in contact with: (i) the second silicon layer (105) of the second composite electrode material (111); and (ii) the first silicon layer (105) of the third composite electrode material (112);
f. providing an electrode tab material (103);
g. providing a welding material (104) possessing a thickness of from 0.1 to 500 μm between and in contact with: (i) the first silicon layer (105) of the first composite electrode material (109); and (ii) the electrode tab material (103);
h. applying ultrasonic energy to a portion of the aligned electrode assembly stack (116) to form a penetration weld connecting the electrode tab (103) through the welding materials (104, 114, 115), and through the silicon layers (105) with a thickness of from 0.1 to 500 μm to the current collector material foils (106), thereby forming the electrode assembly.

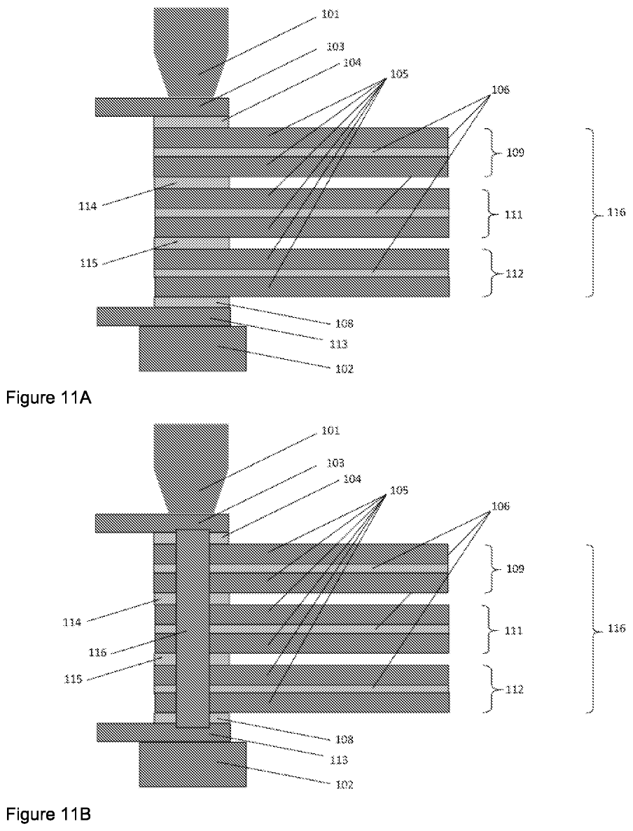

FIG. 11A depicts this particularly preferred embodiment E5. FIG. 11B depicts this particularly preferred embodiment E5 after welding, depicting in cartoon form the penetration weld (116). The composition of the penetration weld (116) is electrically conducting. The composition of the penetration weld (116) varies from top to bottom, and comprises material originally found in the layers (103, 104, 105, 106).

This particularly preferred embodiment E5 allows the current collector material of multiple anodes to be directly connected to an electrode tab, allowing more condensed anode assemblies. In particular, contact tabs may be brought into electrical communication with the current collector material though an electrically conductive weld that penetrates the silicon layer with a thickness of from 0.1 to 500 μm without the silicon layer exhibiting significant:
(i) ablation of parts of the silicon layer from the current collector material;
(ii) delamination of parts of the silicon layer from the current collector material; or
(iii) cracking of the current collector material.

This result is exceptionally surprising in allowing multiple silicon layers of different electrode assemblies, such as anodes, to be welded together, given that thin layers of silicon with a thickness of from 0.1 to 500 μm tend to be frangible, and generally tend to ablate and delaminate from the current collector under thermal or physical stress of traditional welding techniques.

The product directly obtained by the method of this embodiment E5 may be distinguished from those made by known methods in that the weld penetrates both the silicon layers with a thickness of from 0.1 to 500 μm and does not exhibit ablation or delamination near the weld site. This may be confirmed by scanning electron microscopy of a cross section of the weld.

In the absence of the welding material between the silicon layers of alternating composite electrode material layers, poor adhesion between the silicon layers is observed.

Optionally, there may be the further steps g1 and g2 before step h, of:
g1: providing a second electrode tab material; and
g2: providing a welding material possessing a thickness of from 0.1 to 500 μm between and in contact with: (i) the second silicon layer of the third composite electrode material; and (ii) the second electrode tab material.

### DETAILED DESCRIPTION OF THE FIGURES

The invention will now be discussed with reference to the figures, which show preferred exemplary embodiments of the subject invention.

FIG. 1A shows a schematic representation of an electrode assembly stack (100) according to the invention, prior to or during ultrasonic welding, in contact with the horn (101) and anvil (102) of an ultrasonic welding apparatus. The horn (101) is shown pressing down on top of the stack. The stack comprises in sequence the electrode tab (103), a first welding material layer (104), a first silicon material layer (105), a current collector layer (106), a second silicon material layer (107), and a second (optional) welding material layer (108). The anvil (102) is shown holding in place the bottom of the stack. A composite electrode material (109) comprises the first and second silicon material layers (105, 107) and the current collector layer (106).

FIG. 1B shows a schematic representation of an electrode assembly stack (100) according to the invention, prior to or during ultrasonic welding, in contact with the horn (101) and anvil (102) of an ultrasonic welding apparatus. The horn (101) is shown pressing down on top of the stack. The stack comprises in sequence the electrode tab (103), a first welding material layer (104), a current collector layer (106), two silicon material layers (105), a current collector layer (106), and a second (optional) welding material layer (108). The anvil (102) is shown holding in place the bottom of the stack. A first composite electrode material (109) comprises one current collector layer (106) and one silicon material layer (105). A second composite electrode material (110) comprises one current collector layer (106) and one silicon material layer (105).

The electrode assembly stacks presented in FIGS. 1A and 1B can be welded according to the invention and result in electrode assemblies according to the invention wherein each component is in electrical communication with each other component and wherein all components are held together with a more than sufficient adhesive strength necessary for commercial operability of the electrode assembly. This is in contrast to similar assembly stacks as presented in FIGS. 1A and 1B, but wherein no welding material layer is present between the electrode tab and the composite material. Such assemblies do not result in assemblies with a sufficient adhesive strength and electrical communication necessary for commercial operability of the electrode assembly, because a minor pulling force applied on either end of the assembly separates one or more of the layers from the other layers of the assembly.

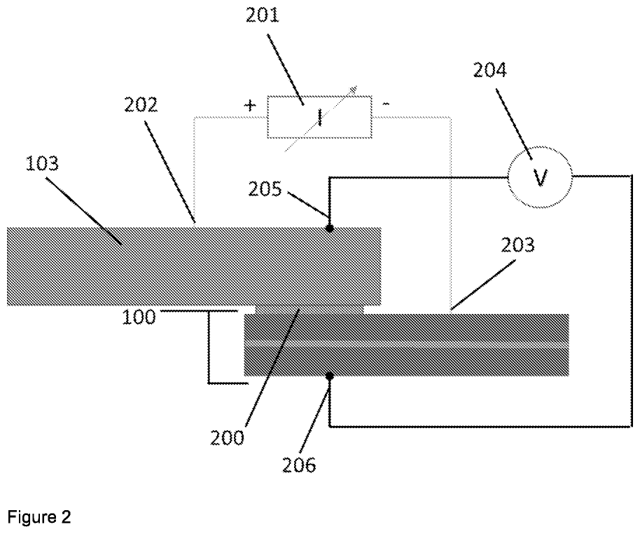

FIG. 2 shows a schematic representation of an electrode assembly (100) according to the invention attached to a circuit for four-point contact resistance measurement. The tab material (103) is welded to the electrode assembly (100) via a weld (200) comprising weld material generated by ultrasonic welding. A battery (201) providing a current is attached with a first terminal (202) to a proximal point on the electrode tab and with the second terminal (203) to a proximal point on the electrode assembly. A volt-ohm-milliammeter (204) is attached at a proximal point (205) on the electrode tab and on a distal point (206) on the electrode assembly. The volt-ohm-milliammeter (204) can be used to determine the resistance between the two contact points (205, 206) of the volt-ohm-milliammeter (204), thereby verifying the electrical communication of the circuit comprising the ultrasonically welded tab material, weld material, composite material, and optionally the welding material.

FIG. 3A shows the top view of a welded electrode tab (300) of an electrode assembly according to the invention. Bright, squared indentations (301) can be seen where the sonotrode of the ultrasonic welding apparatus was pressed against the dark nickel electrode tab (300). Small patches of copper-coloured welding or weld material can be seen on the bright squared indentations. Copper welding material (302) underneath the electrode tab (300) and silicon (303) underneath the copper welding material (302) can also be seen.

FIG. 3B shows the bottom view of an electrode assembly according to the invention, wherein a layer of copper welding material (400) was placed on the bottom. A heterogeneously structured alloy of bright circular spots (401) can be seen surrounded by a sheet of copper welding material (400).

FIG. 3C shows the bottom view of an electrode assembly according to the invention, wherein no layer of welding material was placed on the bottom. A heterogeneously structured alloy of bright circular spots (500) can be seen surrounded by a layer of silicon material (501).

FIG. 3D shows a cross section view of an electrode assembly according to the invention. A nickel electrode tab (600) can be seen welded on top of five layers of composite electrode materials (601), each layer comprising copper current collector material and silicon active material. A copper welding material layer (602) can be seen outside of the welding area.

FIG. 4 shows a scanning electron microscopic image of a cross sectional view of an electrode assembly according to the invention (700), wherein the electrode assembly stack prior to ultrasonic welding consisted of a top nickel tab, copper welding material, one silicon layer on each side of a copper current collector material and copper welding material on the bottom. Indentations (701) can be seen in the nickel electrode tab material (702) where the sonotrode was applied during welding.

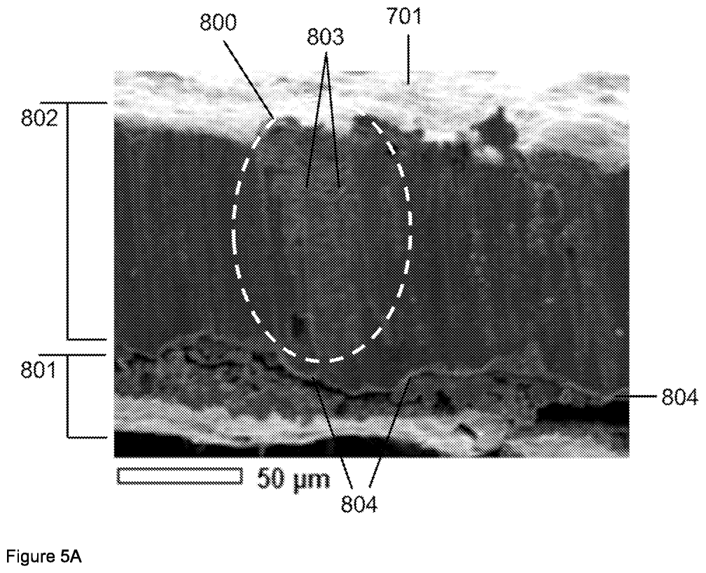

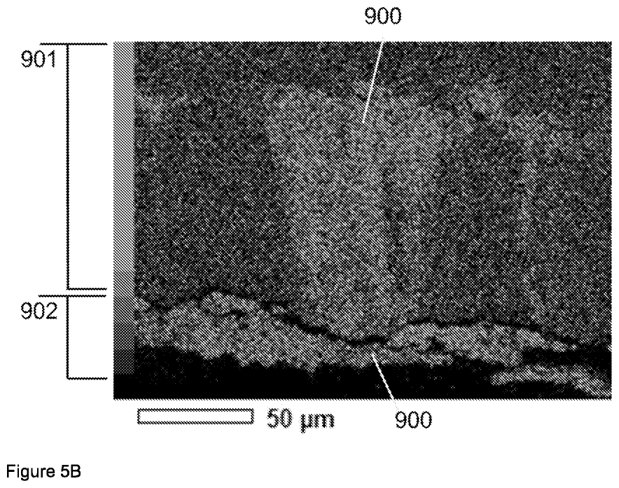

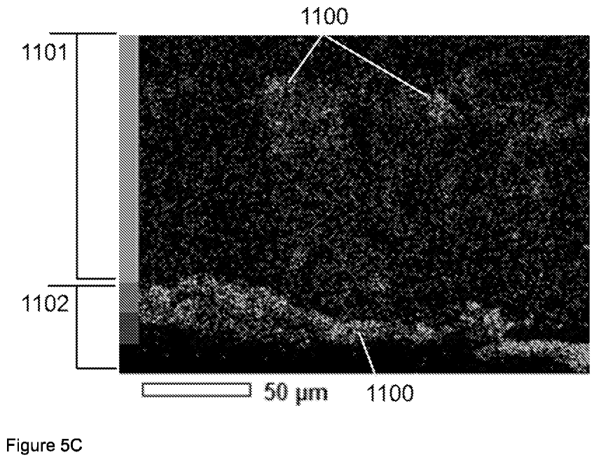

FIG. 5A shows an enlarged view of part of FIG. 4 directly underneath a bright welding indentation (701). An area comprising bright copper welding material extending from bottom to top and dark nickel tab electrode material is encircled (800), the area is also termed weld material according to the invention. The encircled area (800) may also be considered to contain weld interface material (803), preferably a first weld interface material. Near the bottom of the encircled area at the intersection of the composite electrode material (801) and the nickel tab material (802) a bright layer of weld interface material (804) can be seen, preferably a second weld interface material.

FIG. 5B shows the same view as FIG. 5A, but presented with intensity levels representing the density of copper as measured by energy-dispersive X-ray spectroscopy. The level of density is represented by the level of grayscale of the image, wherein the density is higher where the image is whiter. The copper welding material (900) can be seen to have penetrated through the entire height of the electrode tab material (901), while also having dispersed throughout the entire composite electrode material (902).

FIG. 5C shows the same view as FIG. 5A, but presented with intensity levels representing the density of silicon as measured by energy-dispersive X-ray spectroscopy. The level of density is represented by the level of grayscale of the image, wherein the density is higher where the image is whiter. Silicon (1100) can be seen to be mostly located in its original pre-weld position in the composite electrode material (1102), but parts have also been dispersed throughout the tab electrode material (1101) and the current collector material layer.

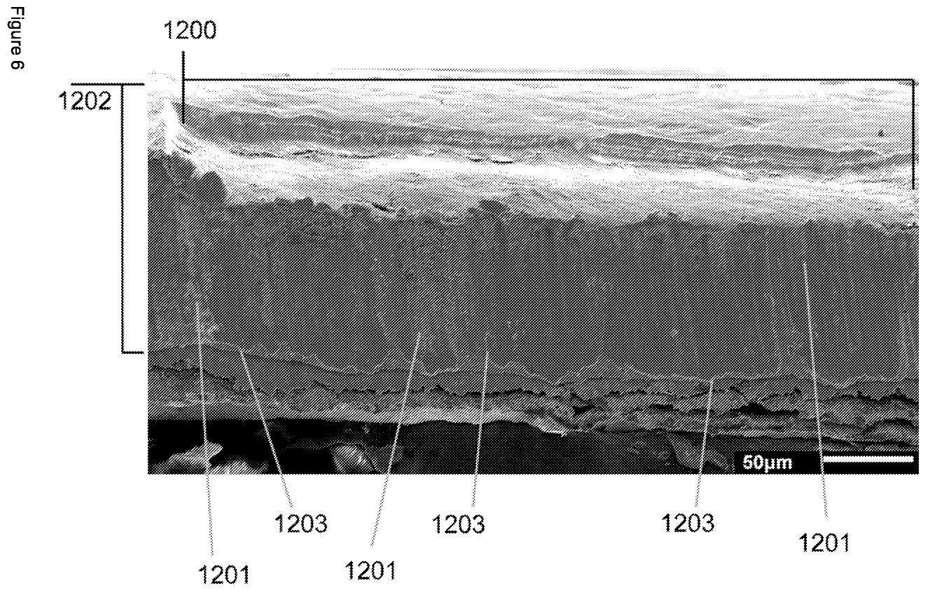

FIG. 6 shows a scanning electron microscopic image of a cross sectional view of an electrode assembly according to the invention at a higher magnification than FIG. 4, wherein the electrode assembly stack prior to ultrasonic welding consisted of a top nickel tab, copper welding material, one silicon layer on each side of a current collector material and welding material on the bottom. An indentation formed by the sonotrode in contact with the tab material can be seen on top (1200). An abundance of bright areas of weld material (1201) can be seen to be present in the electrode tab material (1202) and an almost continuous brighter weld interface material layer (1203) can be seen near the bottom of the electrode tab material.

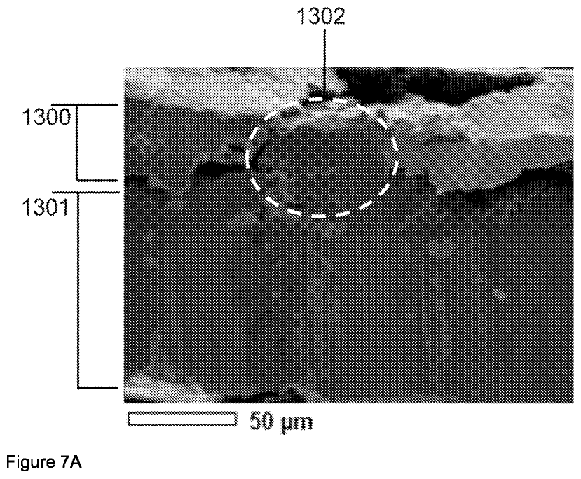

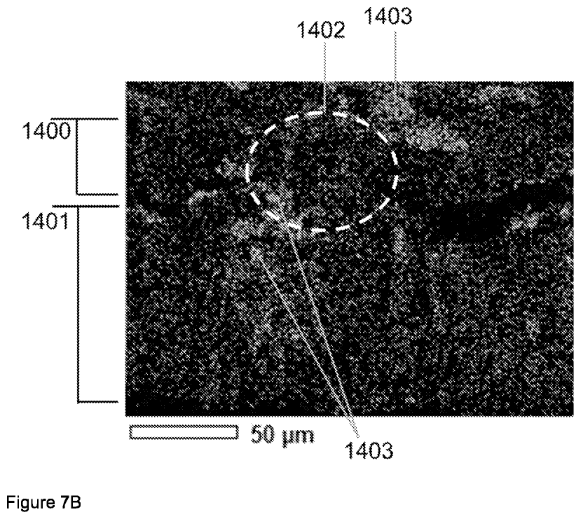

FIG. 7A shows a scanning electron microscopic image of a cross sectional view of an electrode assembly according to the invention with a connection between the nickel tab layer (1301) and the copper welding material layer (1300) at the encircled weld point (1302), whereby a weld material was created.

FIG. 7B shows the same view as FIG. 7A, but presented with intensity levels representing the density of silicon as measured by energy-dispersive X-ray spectroscopy. The level of density is represented by the level of grayscale of the image, wherein the density is higher where the image is whiter. Silicon (1403) originating from the composite electrode material located above the copper welding material (1400) can be seen to be present in the encircled welding point (1402) and the tab material (1401).

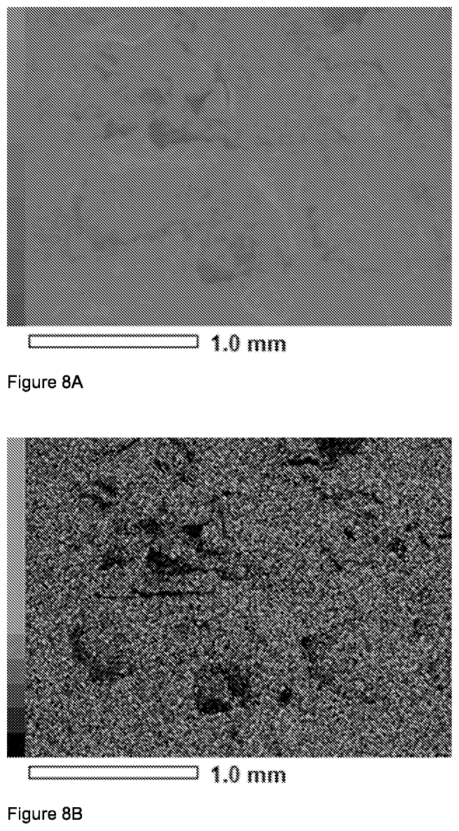

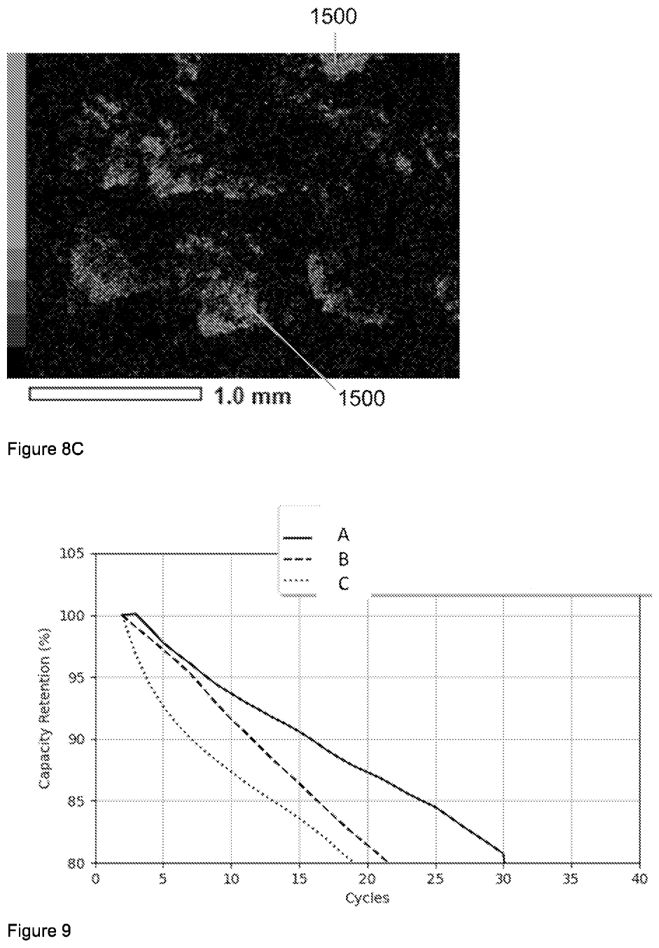

FIG. 8A shows a scanning electron microscopic image of a bottom view of an electrode assembly according to the invention, wherein the electrode assembly stack prior to ultrasonic welding consisted of a top tab, welding material, one silicon layer on each side of a current collector material and welding material on the bottom.

FIG. 8B shows the same view as FIG. 8A, but presented with intensity levels representing the density of copper as measured by energy-dispersive X-ray spectroscopy. The level of density is represented by the level of grayscale of the image, wherein the density is higher where the image is whiter. Copper material can be seen to be clearly present throughout the image except for a couple of smaller dark areas.

FIG. 8C shows the same view as FIG. 8A, but presented with intensity levels representing the density of silicon as measured by energy-dispersive X-ray spectroscopy. The level of density is represented by the level of grayscale of the image, wherein the density is higher where the image is whiter. Silicon material (1500) can be seen to have penetrated through the copper welding material. Nickel is not visible.

FIG. 9 shows the capacity retention over several charge/recharge cycles comparing three three-anode pouch cell batteries, each having different tab connections. The battery indicated by line A has a tab attached to current collector material wherein the silicon active layer has been removed by potassium etching. The battery indicated by line B has a tab attached to the silicon active material layer according to the invention. The battery indicated by line C has a tab attached to the current collector wherein the silicon active material layer was not deposited on the current collector material because of masking of the current collector material layer. During the first 10 cycles a battery made according to the invention (line B) can be seen to have a similar capacity retention percentage as a battery with a tab attached to current collector material wherein the silicon active layer has been removed by potassium etching (line A), while it has a better capacity retention percentage than a battery with a tab attached to the current collector wherein the silicon active material layer was not deposited on the current collector material because of masking of the current collector material layer (line C).

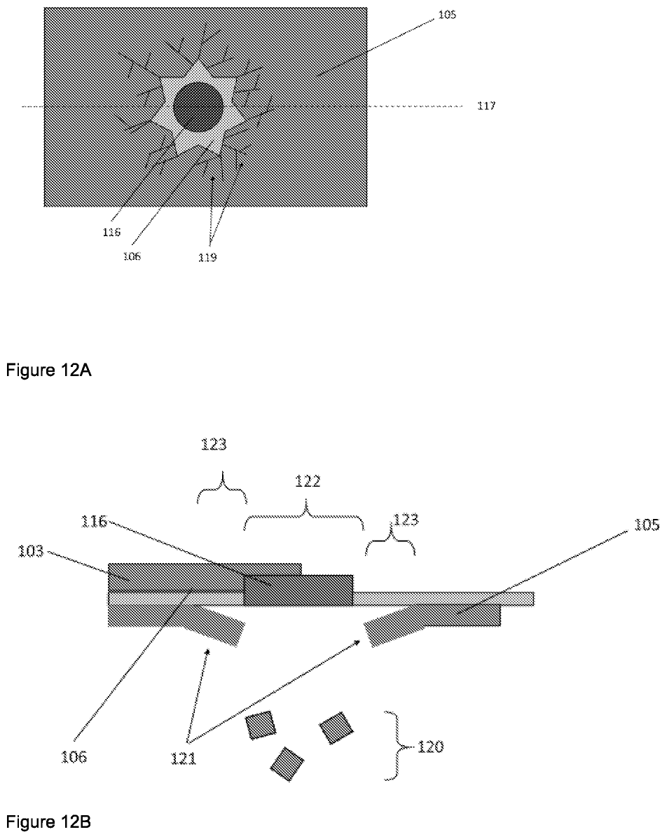

FIGS. 12A and 12B depict a state of the art weld of a composite electrode comprising at least one silicon layer with a thickness of from 0.1 to 500 μm on a current collector material foil with at thickness of from 1 to 100 μm. FIG. 12A depicts the bottom of the welded composite electrode. FIG. 12B depicts a cross section along (117) of FIG. 12B. They depict:
(i) significant ablation of parts of the silicon layer (105) from the current collector material around the weld (116), exposing the current collector material (106). This is disadvantageous, as ablated silicon material (120) cannot contribute to the charge storage of the composite electrode, disadvantageously lowering its charge density. Further, ablated silicon material (120) increases the surface area of the silicon layer, which may deleteriously accelerate electrolyte decomposition, making it less suitable for use in battery materials due to a reduced number of charge cycles that are possible.
(ii) Delamination of parts of the silicon layer from the current collector material (121). This is disadvantageous, as delaminated silicon material (121) is no longer in direct contact with the current collector (116) and therefore cannot contribute to the charge storage of the composite electrode, disadvantageously lowering its charge density.
(iii) Cracking (119) of the current collector material. This increases the surface area of the silicon layer, which may deleteriously accelerate electrolyte decomposition, making it less suitable for use in battery materials due to a reduced number of charge cycles that are possible.

The following, non-limiting examples illustrate the process and materials according to the invention.

### Comparative Example 1A

A nickel tab with a thickness of 100 μm was ultrasonically welded onto a single sheet of bare copper foil welding material.

### Comparative Example 1B

A nickel tab with a thickness of 100 μm was ultrasonically welded onto a silicon-coated copper foil (10 μm thick foil coated on both sides with a 10 μm thick layer of porous silicon active material; i.e. composite electrode material according to the invention). For the silicon-coated copper foil the welding methods was used: ultrasonically welding nickel tab material directly onto silicon.

The nickel tab was placed on the silicon layer of the silicon-coated copper foil, thereby forming an aligned electrode assembly stack. The stack was placed between the horn and anvil of a GN-800 ultrasonic welding apparatus (manufactured by GELON) similar to the orientation as presented in FIG. 1A, but without the welding material layers (104) and (108) being present. An ultrasonic weld was subsequently attempted to be made by using the ultrasonic welding apparatus set at a power of 800 W, for 3 s, with a pressure of 414 kPa across a sonotrode to nickel tab contact surface area of about 3 by 3 mm. This method failed to generate any adhesion between the tab material and the silicon, and the tab material and the silicon readily detached.

### Example 1

A nickel tab with a thickness of 100 μm was ultrasonically welded onto a silicon-coated copper foil (10 μm thick foil coated on both sides with a 10 μm thick layer of porous silicon active material; i.e. composite electrode material according to the invention). For the silicon-coated copper foil the welding methods was used: the method according to the invention, comprising adding a copper foil welding material with a thickness of 10 μm between the nickel tab and the silicon and using ultrasonic welding.

The nickel tab was placed on the copper foil welding material with a thickness of 10 μm which was in turn placed on the silicon layer of the silicon-coated copper foil, thereby forming an aligned electrode assembly stack. The stack was placed between the horn and anvil of a GN-800 ultrasonic welding apparatus (manufactured by GELON) similar to the orientation as presented in FIG. 1A, but without the welding material layer (108) being present. An ultrasonic weld was subsequently made by using the ultrasonic welding apparatus set at a power of 800 W, for 3 s, with a pressure of 414 kPa across a sonotrode to nickel tab contact surface area of about 3 by 3 mm, thereby producing an electrode assembly according to the invention.

The contact resistance of the electrode assemblies as a result of the two different welding methods was compared (Comparative Example 1B and Example 1) using four-point probe measurements according to FIG. 2.

The failure of the method of Comparative Example 1B to generate a bond between the tab material and the silicon prevented an effective contact resistance measurement.

The four-point probe contact resistance measurement for the method Example 1 resulted in values of less than 10 mΩ.

1. A method for producing an electrode assembly, the method comprising the steps of:
a) providing at least a first composite electrode material comprising at least one silicon layer on a current collector material;
b) providing a welding material in contact with the composite material; and
c) providing an electrode tab material in contact with the welding material, to form an aligned electrode assembly stack; and
d) optionally, repeating steps a and/or b; and
e) applying ultrasonic energy to a portion of the aligned electrode assembly stack to form:
i) a weld material;
ii) a penetration weld through the electrode tab and the welding material and optionally through the composite material; and/or
iii) at least an attachment weld between the weld material and the composite material;
thereby forming the electrode assembly.

2. The method according to claim 1, wherein at least part of the weld material and the tab material form a first weld interface material and at least part of the weld material and the composite material form a second weld interface material.

3. The method according to claim 1, wherein the welding material is brought in contact with the at least one silicon layer of the composite material.

4. The method according to claim 1, wherein the composite material comprises at least one layer of silicon on each of two sides of the current collector material.

5. The method according to claim 1, wherein the materials are essentially flat, sheet-like materials, and
wherein the materials are aligned and fixed prior to, and during the welding process.

6. The method according to claim 1, wherein the welding material comprises aluminium, gold, copper, iron, lithium, manganese, palladium, platinum, thulium, titanium, tungsten, silver, beryllium, magnesium, nickel, silicon and/or zirconium, preferably copper.

7. (canceled)

8. The method according to claim 1, wherein the current collector material comprises a metal, metal alloy and/or metal salts and/or oxide, wherein the metal, metal alloy and/or metal salts and/or oxide are selected from aluminium, copper, nickel, tin, tin, indium and zinc; preferably, wherein the current collector comprises a copper or nickel core layer, more preferably a core layer doped with oxides or fluorides of zinc, aluminium, tin or indium, at a thickness of from 0.1 to 5 nm, more preferably 1 to 2 nm.

9. The method according to claim 1, wherein the at least one silicon layer has a porosity of from 0% to 50%, more preferably of from 5% to 50%, as determined according to the method specified by the ISO standard: ISO 15901-2:2006 “Pore size distribution and porosity of solid materials by mercury porosimetry and gas adsorption—Part 2: Analysis of mesopores and macropores by gas adsorption” using nitrogen gas.

10. The method according to claim 1, wherein the tab material comprises nickel or copper or an alloy comprising nickel, copper, tin, silicon, copper and nickel, copper and tin or copper and silicon.

11. The method according to claim 10, wherein if the tab material comprises nickel, the welding material is selected from materials comprising aluminium, gold, copper, iron, lithium, manganese, palladium, platinum, thulium, titanium, tungsten or combinations thereof; and
if the tab material comprises copper but not nickel, the welding material is selected from materials comprising silver, aluminium, gold, beryllium, copper, iron, magnesium, manganese, nickel, palladium, platinum, silicon, thulium, titanium, tungsten, zirconium or combinations thereof.

12. The method according to claim 1, wherein the first weld interface material comprises the tab material and the welding material or an alloy thereof, preferably the tab material and the welding material and the composite material or an alloy thereof; and
wherein the second weld interface material comprises the welding material and the composite material, preferably silicon, or an alloy thereof, preferably the tab material and the welding material and the composite material or an alloy thereof.

13. The method according to claim 1, wherein the current collector material comprises copper, tin, chromium, nickel, titanium, stainless steel or silver, or an alloy comprising copper, tin, chromium, nickel, titanium, stainless steel or silver.

14. The method according to claim 1, wherein the weld material extends into or penetrates the composite material throughout at least 0.1 to 1% of a dimension of the composite material.

15. A method for connecting two or more electrode assemblies according to claim 1, the method comprising the steps of:
a) contacting the silicon of the composite of a first electrode assembly with either:
i) a welding layer or a current collector of a second electrode assembly; or
ii) a welding layer contacted with a second electrode assembly;
b) contacting the welding layer or the current collector with an electrode tab;
c) applying ultrasound energy to at least the electrode tab, thereby generating a weld material, wherein at least part of the weld material and the composite material form a weld interface material, and welding the first electrode assembly to the second electrode assembly.

16. An electrode assembly comprising:
i) an electrode tab comprising a weld material, wherein at least part of the weld material and the tab material form a first weld interface material;
ii) a silicon electrode composite material comprising the weld material and a silicon active material layer on a current collector material layer, preferably wherein at least part of the weld material and the composite material, preferably silicon, form a second weld interface material; and
iii) the weld material adjoining the electrode tab and the composite, preferably the silicon material, such that tab, composite and weld material are joined in electrical communication with each other.

17. The electrode assembly according to claim 16, wherein the weld material is an ultrasonic weld material.

18. The electrode assembly according to claim 16, comprising a welding material.

19. (canceled)

20. The electrode assembly according to claim 16, wherein the tab material comprises nickel or copper or an alloy comprising nickel, copper, tin, silicon, copper and tin or copper and silicon and wherein the weld material, the welding material or the weld interface material comprises aluminium, gold, copper, iron, lithium, manganese, palladium, platinum, thulium, titanium, tungsten, silver, beryllium, magnesium, nickel, silicon or zirconium.

21. The electrode assembly according to claim 16, wherein the first interface weld material comprises the tab material and the weld material or an alloy thereof, preferably the tab material, the weld material and the composite material, preferably silicon, or an alloy thereof; and wherein the second weld interface material comprises the weld material or the welding material and the composite material, preferably silicon, or an alloy thereof, preferably the tab material, the weld material or the welding material, and the composite material, preferably silicon, or an alloy thereof.

22. (canceled)

23. A battery comprising an electrolyte, a cathode, a separator and the assembly obtainable according to the method according to claim 1.
